(19) United States
(12) Patent Application Publication
(10) Pub. No.: US 2008/0241666 A1
(43) Pub. Date: Oct. 2, 2008

(54) Battery unit

(76) Inventors: Yasunori Baba, Osaka (JP); Naoki Imachi, Osaka (JP); Shin Fujitani, Osaka (JP)

Correspondence Address: KUBOVCIK & KUBOVCIK, SUITE 1105, 1215 SOUTH CLARK STREET, ARLINGTON, VA, 22202, US

(21) Appl. No.: 12/010,857

(22) Filed: Jan. 30, 2008

(30) Foreign Application Priority Data
Feb. 5, 2007 (JP) 2007-024977

(51) Int. Cl. H01M 6/42; H01M 4/52; H01M 4/50; H01M 4/40

(52) U.S. Cl. 429/158; 429/221; 429/223; 429/224; 429/231.3; 429/231.95

(57) ABSTRACT

A battery unit has a plurality of non-aqueous electrolyte secondary batteries connected in series, wherein at least two types of non-aqueous electrolyte secondary batteries (A1), (B1a) having different potentials at which lithium is released from the positive electrode active material and at which the electrical resistance in the battery increases during charge are connected in series.

### BACKGROUND OF THE INVENTION

1. Field of the Invention

The present invention relates to battery units in which a plurality of non-aqueous electrolyte secondary batteries are connected in series, and more particularly to a battery unit in which the non-aqueous electrolyte secondary batteries connected in series are prevented easily from being brought into an overcharge condition while keeping the output power of the battery unit high so that greater safety is obtained.

2. Description of Related Art

Non-aqueous electrolyte secondary batteries have been widely in use as new types of high power, high energy density secondary batteries. A non-aqueous electrolyte secondary battery typically uses a non-aqueous electrolyte and performs charge-discharge operations by transferring lithium ions between the positive electrode and the negative electrode.

In recent years, such non-aqueous electrolyte secondary batteries have been used also as power sources of power tools, electric vehicles, hybrid electric vehicles, and the like.

When non-aqueous electrolyte secondary batteries are used as power sources for power tools, electric vehicles, hybrid electric vehicles, and the like, very high output power and high capacity are required.

For this reason, battery units in which a plurality of non-aqueous electrolyte secondary batteries as described above are connected in series are used, and battery modules in which a plurality of such battery units are connected in parallel are also used as needed.

When a plurality of non-aqueous electrolyte secondary batteries are connected in series and used in the form of a battery unit or a battery module, the greater the number of the non-aqueous electrolyte secondary batteries connected, the worse the heat dissipation properties in the battery unit or the battery module. In particular, when non-aqueous electrolyte secondary batteries that use a layered lithium-transition metal composite oxide such as lithium cobalt oxide (LiCoO₂) or lithium nickel oxide (LiNiO₂) as the positive electrode active material are used in order to obtain a high power, the safety of the battery unit and the battery module significantly worsens if the batteries are overcharged during charge.

In view of the above problem, it has been proposed to provide various safety mechanisms such as protection circuits for preventing overcharge and fans for preventing increase of the battery temperature.

Moreover, in order to meet the demands of higher power and higher capacity requirements, further safety measures have been necessary, and developments of safety mechanisms not only in battery units and battery modules but also in the non-aqueous electrolyte secondary batteries themselves have been necessary.

Conventionally, the use of a metallic lithium composite oxide having a layered structure or a spinel structure and an olivine-type lithium phosphate compound such as an olivine-type lithium iron phosphate (LiFePO₄) as the positive electrode active material has been proposed in order to improve the safety of the non-aqueous electrolyte secondary batteries (for example, see Japanese Published Unexamined Patent Application No. 2002-216755 and U.S. Patent Application Publication No. 2006-0019151).

However, a problem with the use of a plurality of the non-aqueous electrolyte secondary batteries containing a metallic lithium composite oxide having a layered structure or a spinel structure and an olivine-type lithium phosphate compound such as an olivine-type lithium iron phosphate (LiFePO₄) that are connected in series is that it is difficult to obtain a high output power.

### BRIEF SUMMARY OF THE INVENTION

It is an object of the present invention to solve such problems in the battery units in which a plurality of non-aqueous electrolyte secondary batteries are connected in series. More specifically, it is an object of the present invention to easily prevent a battery unit in which non-aqueous electrolyte secondary batteries are connected in series from being brought into overcharge conditions while keeping the output power of the battery unit high so that greater safety is obtained, when such battery unit is utilized as, for example, a power source for electric power tools, electric vehicles, and hybrid electric vehicles.

In order to accomplish the foregoing and other objects, the present invention provides a battery unit comprising a plurality of non-aqueous electrolyte secondary batteries connected in series, wherein at least two types of non-aqueous electrolyte secondary batteries having different potentials at which lithium is released from the positive electrode active material and the electrical resistance in the battery increases during charge are connected in series.

In the above-described battery unit, the non-aqueous electrolyte secondary batteries may include a first non-aqueous electrolyte secondary battery having a higher potential at which lithium is released from the positive electrode active material and the electrical resistance in the battery increases during charge, and a second non-aqueous electrolyte secondary battery having a lower potential at which lithium is released from the positive electrode active material and the electrical resistance in the battery increases during charge than the first non-aqueous electrolyte secondary battery.

It is preferable that the positive electrode active material in the first non-aqueous electrolyte secondary battery, which has a higher potential at which lithium is released from the positive electrode active material and the electrical resistance in the battery increases during charge, contain a layered lithium-transition metal composite oxide, which serves to obtain high power, such as a lithium-transition metal composite oxide containing at least one element selected the group consisting of cobalt and nickel, such as lithium cobalt oxide (LiCoO₂) and lithium nickel oxide (LiNiO₂).

On the other hand, it is preferable that the positive electrode active material in the second non-aqueous electrolyte secondary battery, which has a lower potential at which lithium is released from the positive electrode active material and the electrical resistance in the battery increases during charge than the first non-aqueous electrolyte secondary battery, contain an olivine-type lithium phosphate compound represented by the general formula LiMPO₄, where M is at least one element selected from the group consisting of Fe, Ni, and Mn, or a spinel-type lithium-manganese composite oxide.

In the second non-aqueous electrolyte secondary battery, the olivine-type lithium phosphate compound used as the positive electrode active material may be an olivine-type lithium iron phosphate (LiFePO₄), and the spinel-type lithium-manganese composite oxide used as the positive electrode active material may be a spinel lithium manganese oxide (LiMn₂O₄), for example.

In the second non-aqueous electrolyte secondary battery, in addition to using the positive electrode active material containing the olivine-type lithium phosphate compound or the spinel-type lithium-manganese composite oxide alone, it is also possible to use a positive electrode active material containing the above-mentioned layered lithium-transition metal composite oxide in combination with the foregoing positive electrode active material.

When the layered lithium-transition metal composite oxide is used in combination with the positive electrode active material containing an olivine-type lithium phosphate compound or a spinel-type lithium-manganese composite oxide in the second non-aqueous electrolyte secondary, it is preferable that the positive electrode of the second non-aqueous electrolyte secondary battery comprise a first layer and a second layer stacked on a positive electrode current collector, the first layer comprising a positive electrode active material containing an olivine-type lithium phosphate compound as described above or a spinel-type lithium-manganese composite oxide, and the second layer comprising a positive electrode active material containing a layered lithium-transition metal composite oxide.

In addition, it is preferable that the second non-aqueous electrolyte secondary battery be furnished with a current shut-off valve that is actuated by a battery internal pressure increase.

### BRIEF DESCRIPTION OF THE DRAWINGS

FIGS. 1A and 1B illustrate a schematic plan view and a partial cross-sectional view of an electrode assembly used in preparing non-aqueous electrolyte secondary batteries A1, B1a, and B1b of Examples of the present invention;

FIG. 2 is a schematic plan view illustrating the non-aqueous electrolyte secondary batteries A1, B1a, and B1b;

FIG. 3 is a schematic plan view illustrating non-aqueous electrolyte secondary batteries A2 and B2, fabricated in Examples the present invention;

FIG. 4 is a schematic illustrative drawing showing a battery unit of Example 1, in which the non-aqueous electrolyte secondary batteries A1 and B1a are connected to each other in series;

FIG. 5 is a schematic illustrative drawing showing a battery unit of Example 1, in which the non-aqueous electrolyte secondary batteries A1 and B1b are connected to each other in series;

FIG. 6 is a schematic illustrative drawing showing a battery unit of Comparative Example 1, in which two non-aqueous electrolyte secondary batteries A1 are connected to each other in series;

FIG. 7 is a schematic illustrative drawing showing a battery unit of Example 3, in which the non-aqueous electrolyte secondary batteries A2 and B2 are connected to each other in series; and

FIG. 8 is a schematic illustrative drawing showing a battery unit of Comparative Example 2, in which two non-aqueous electrolyte secondary batteries A2 are connected to each other in series.

### DETAILED DESCRIPTION OF THE INVENTION

In the battery unit of the present invention, at least two types of non-aqueous electrolyte secondary batteries having different potentials at which lithium is released from the positive electrode active material and the electrical resistance in the battery increases are connected in series. Therefore, when such a battery unit is charged, the electrical resistance of the second non-aqueous electrolyte secondary battery, which has a lower potential at which lithium is released from the positive electrode active material and the electrical resistance in the battery increases, greatly increases, preventing the first non-aqueous electrolyte secondary battery, which has a higher potential at which lithium is released from the positive electrode active material and the electrical resistance in the battery increases, from being brought into an overcharge condition. As a result, greater safety is obtained.

Here, in the case that a layered lithium-transition metal composite oxide such as lithium cobalt oxide (LiCoO₂) or lithium nickel oxide (LiNiO₂), is used as the positive electrode active material of the first non-aqueous electrolyte secondary battery, not all the lithium ions are released from the positive electrode active material and about 50% of lithium ions in the case of LiCoO₂ or about 25% of lithium ions in the case of LiNiO₂ remains therein even when the battery is charged to about 4.2 V (4.3 V versus the potential of a lithium reference electrode), which is the upper limit of the charge voltage in commonly-used non-aqueous electrolyte secondary batteries. When the battery is charged to an even higher voltage, lithium ions are further released therefrom and the battery is brought into an overcharge condition, which is unstable in terms of energy, so the thermal stability is greatly degraded.

In view of this, the positive electrode active material of the second non-aqueous electrolyte secondary battery contains an olivine-type lithium phosphate compound or a spinel-type lithium-manganese composite oxide. As a result, when the battery is charged to about 4.2 V (4.3 V versus the potential of a lithium reference electrode), which is the upper limit of the charge voltage in commonly-used non-aqueous electrolyte secondary batteries, all the lithium ions in the crystals are released from the positive electrode active material and the electrical resistance greatly increases in the case of such a positive electrode active material, thereby lowering the electric current flowing through the second non-aqueous electrolyte secondary battery significantly.

Thus, when the battery unit in which the first non-aqueous electrolyte secondary battery and the second non-aqueous electrolyte secondary battery are connected in series is charged to about 4.2 V (4.3 V versus the potential of a lithium reference electrode), which is the upper limit of the charge voltage in the non-aqueous electrolyte secondary batteries, the electrical resistance greatly increases in the second non-aqueous electrolyte secondary battery as described above, and the electric current flowing through the battery unit significantly lowers, preventing the first non-aqueous electrolyte secondary battery from being brought into an overcharge condition. Therefore, greater safety is obtained.

In addition, when the positive electrode active material of the first non-aqueous electrolyte secondary battery contains a layered lithium-transition metal composite oxide such as lithium cobalt oxide (LiCoO₂) or lithium nickel oxide (LiNiO₂), a high power battery unit can be obtained because of the first non-aqueous electrolyte secondary battery.

Moreover, the positive electrode active material of the second non-aqueous electrolyte secondary battery may comprise the above-described layered lithium-transition metal composite oxide in combination with the olivine-type lithium phosphate compound or the spinel-type lithium-manganese composite oxide. In this case, a battery unit that achieves an even higher power can be obtained in comparison with the case that the positive electrode active material of the second non-aqueous electrolyte secondary battery is the olivine-type lithium phosphate compound alone or the spinel-type lithium-manganese composite oxide alone.

Furthermore, when the layered lithium-transition metal composite oxide in combination with the olivine-type lithium phosphate compound or the spinel-type lithium-manganese composite oxide is used for a positive electrode active material of the second non-aqueous electrolyte secondary battery as described above, the second non-aqueous electrolyte secondary battery may have a first layer and a second layer stacked on a positive electrode current collector, the first layer comprising a positive electrode active material containing the olivine-type lithium phosphate compound or the spinel-type lithium-manganese composite oxide and the second layer comprising a positive electrode active material containing a layered lithium-transition metal composite oxide. In this case, even when the amount of the positive electrode active material made of the olivine-type lithium phosphate compound or the spinel-type lithium-manganese composite oxide in the first layer is reduced, the olivine-type lithium phosphate compound or the spinel-type lithium-manganese composite oxide in the first layer that is in contact with the positive electrode current collector serves to effectively prevent the battery unit from being brought into an overcharge condition, and at the same time, the layered lithium-transition metal composite oxide in the second layer serves to attain a higher power battery unit.

Furthermore, the second non-aqueous electrolyte secondary battery may be furnished with a current shut-off valve that is actuated by a battery internal pressure increase. As a result, even when the battery internal pressure rises because of the gas produced by decomposition of the non-aqueous electrolyte solution due to a voltage increase, the current shut-off valve is actuated and electric current is cut off. Therefore, the battery unit is further prevented from being brought into an overcharge condition, and even greater safety is obtained.

It should be noted that the first non-aqueous electrolyte secondary battery and the second non-aqueous electrolyte secondary battery may be configured in the same fashion as commonly known non-aqueous electrolyte secondary batteries, except for the use of the above-described positive electrode active materials, and the negative electrode active materials used for their negative electrode, the non-aqueous solvents and solutes used for their non-aqueous electrolyte solution, their separators, and so forth may also be made of commonly known materials.

### EXAMPLES

Hereinbelow, examples of the battery unit according to the present invention will be described in detail along with comparative examples, and it will be demonstrated that the examples of the battery unit are capable of preventing the overcharge conditions. It should be construed, however, that the battery unit according to the present invention is not limited to the following examples, but various changes and modifications are possible without departing from the scope of the invention.

Herein, five types of non-aqueous electrolyte secondary batteries fabricated according to the following manners were used as the non-aqueous electrolyte secondary batteries.

### Non-Aqueous Electrolyte Secondary Battery A1

A non-aqueous electrolyte secondary battery A1 employed a positive electrode, a negative electrode, and a non-aqueous electrolyte that were fabricated in the following manner.

### Preparation of Positive Electrode

Lithium cobalt oxide (LiCoO₂) (12 μm in particle diameter D₅₀) was used as the positive electrode active material. The positive electrode active material, artificial graphite powder (acetylene black made by Denkikagaku Kogyo Kabushiki Kaisha) serving as a conductive agent, and polyvinylidene fluoride (PVdF made by Kureha Corporation)serving as a binder agent were mixed at a mass ratio of 92:5:3 in a N-methyl-2-pyrrolidone solvent, to prepare a positive electrode mixture slurry. The resultant positive electrode mixture slurry was applied onto both sides of a positive electrode current collector made of an aluminum foil, and then dried. The resultant material was pressure-rolled to prepare a positive electrode.

### Preparation of Negative Electrode

Graphite (20 μm in particular diameter D₅₀) serving as the negative electrode material, styrene-butadiene rubber (SBR made by JSR Corporation) serving as a binder agent and carboxymethylcellulose sodium (CMC made by Daicel Chemical Industries, Ltd.) serving as a thickening agent were mixed together at a mass ratio of 98:1:1 in water to prepare a negative electrode slurry. The prepared negative electrode slurry was applied onto both sides of a negative electrode current collector made of a copper foil, and then dried. Thereafter, the resultant material was pressure-rolled, to obtain a negative electrode.

### Preparation of Non-Aqueous Electrolyte Solution

A mixed solvent of 3:7 volume ratio of ethylene carbonate and ethyl methyl carbonate was used as a non-aqueous solvent. LiPF₆ as an electrolyte was dissolved at a concentration of 1 mol/L in the mixed solvent, to obtain a non-aqueous electrolyte.

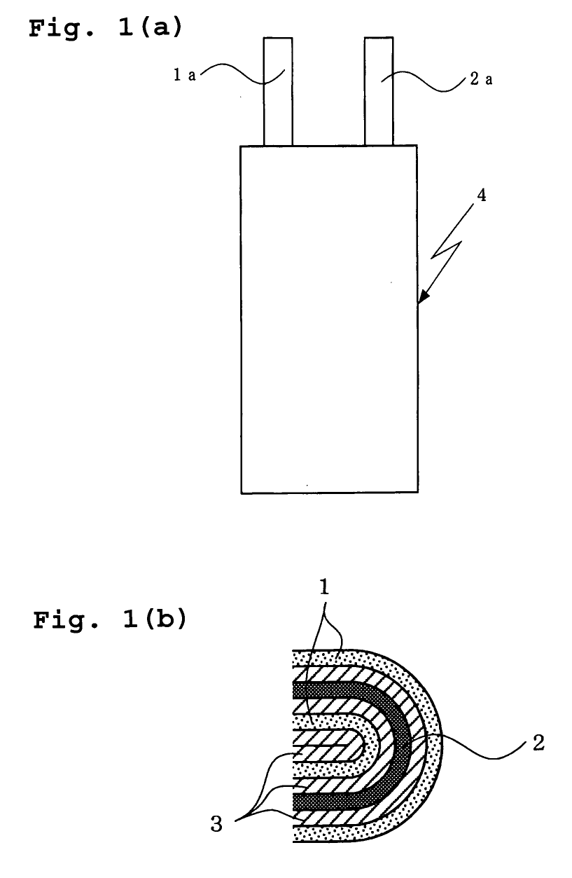

A non-aqueous electrolyte secondary battery A1 was prepared in the following manner. Referring to FIGS. 1(A) and 1(B), a positive electrode current collector tab 1a made of aluminum was attached to the above-described positive electrode 1, and a negative electrode current collector tab 2a made of nickel was attached to the above-described negative electrode 2. Then, the positive electrode 1 and the negative electrode 2 were wound together with a separator 3 made of porous polyethylene so that the separator is interposed between the positive electrode 1 and the negative electrode 2, to thus obtain an electrode assembly 4. This electrode assembly 4 was pressed into a flat shape.

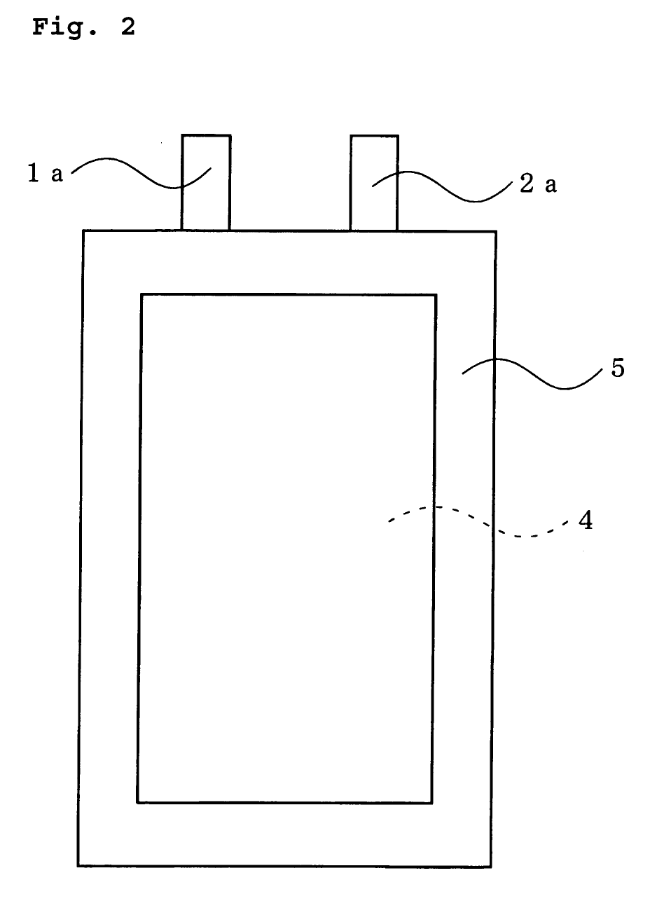

Next, as illustrated in FIG. 2, the electrode assembly 4 thus prepared was put into a battery case 5 made of an aluminum laminate film, and the foregoing non-aqueous electrolyte solution was filled into the battery case 5 while the positive electrode current collector tab 1a and the negative electrode current collector tab 2a were led outside. Also the battery A1 was provided with a separator shutdown mechanism. Thereafter, the opening of the battery case 5 was sealed. Thus, a flat card-shaped non-aqueous electrolyte secondary battery A1 having a design capacity of 780 mAh was obtained.

### Non-Aqueous Electrolyte Secondary Battery B1a

A non-aqueous electrolyte secondary battery B1a was obtained in the same manner as described for the non-aqueous electrolyte secondary battery A1, except that a positive electrode prepared in the following manner was used therein. The flat card-shaped non-aqueous electrolyte secondary battery B1a thus obtained had a design capacity of 780 mAh. The battery B1a was also provided with a separator shutdown mechanism.

In the non-aqueous electrolyte secondary battery B1a, the positive electrode was prepared as follows. An olivine-type lithium iron phosphate (LiFePO₄) (0.5 μm in particle diameter D₅₀) was used as the positive electrode active material. The positive electrode active material, artificial graphite powder (acetylene black made by Denkikagaku Kogyo Kabushiki Kaisha) serving as a conductive agent, and polyvinylidene fluoride (PVdF made by Kureha Corporation) serving as a binder agent were mixed at a mass ratio of 85:10:5 in a N-methyl-2-pyrrolidone solvent, to prepare a positive electrode mixture slurry. The resultant positive electrode mixture slurry was applied onto both sides of a positive electrode current collector made of an aluminum foil, and then dried. The resultant material was pressure-rolled to prepare the positive electrode.

### Non-Aqueous Electrolyte Secondary Battery B1b

A non-aqueous electrolyte secondary battery B1b was obtained in the same manner as described for the non-aqueous electrolyte secondary battery A1, except that a positive electrode prepared in the following manner was used therein. The flat card-shaped non-aqueous electrolyte secondary battery B1b thus obtained had a design capacity of 780 mAh. The battery B1b was also provided with a separator shutdown mechanism.

In the non-aqueous electrolyte secondary battery B1b, the positive electrode was prepared as follows. An olivine-type lithium iron phosphate (LiFePO₄) (0.5 μm in particle diameter D₅₀) was used as a first positive electrode active material. The first positive electrode active material, artificial graphite powder (acetylene black made by Denkikagaku Kogyo Kabushiki Kaisha) serving as a conductive agent, and polyvinylidene fluoride (PVdF made by Kureha Corporation) serving as a binder agent were mixed at a mass ratio of 85:10:5 in a N-methyl-2-pyrrolidone solvent, to prepare a first positive electrode mixture slurry. In addition, lithium cobalt oxide (LiCoO₂) was used as a second positive electrode active material, and the second positive electrode active material, artificial graphite powder serving as a conductive agent, and polyvinylidene fluoride serving as a binder agent were mixed at a mass ratio of 92:5:3 in a N-methyl-2-pyrrolidone solvent, to prepare a second positive electrode mixture slurry.

The first positive electrode mixture slurry was applied onto both sides of a positive electrode current collector made of an aluminum foil to form a first layer containing the first positive electrode active material, i.e., the olivine-type lithium iron phosphate (LiFePO₄), and thereafter, the second positive electrode mixture slurry was applied onto the first layer to form a second layer containing the second positive electrode active material, i.e., lithium cobalt oxide (LiCoO₂). Thereafter, this was dried and pressure-rolled, to thus obtain the positive electrode.

### Non-Aqueous Electrolyte Secondary Battery A2

A non-aqueous electrolyte secondary battery A2 employed a positive electrode, a negative electrode, and a non-aqueous electrolyte that were fabricated in the following manner.

### Preparation of Positive Electrode

A layered lithium-nickel-cobalt-manganese composite oxide (LiNi_{0.3}Co_{0.3}Mn_{0.3}O₂) (10 μm in particle diameter D₅₀) was used as the positive electrode active material. The positive electrode active material, artificial graphite powder (acetylene black made by Denkikagaku Kogyo Kabushiki Kaisha) serving as a conductive agent, and polyvinylidene fluoride (PVdF made by Kureha Corporation) serving as a binder agent were mixed at a mass ratio of 94:3:3 in a N-methyl-2-pyrrolidone solvent, to prepare a positive electrode mixture slurry. The resultant positive electrode mixture slurry was applied onto both sides of a positive electrode current collector made of an aluminum foil, and then dried. The resultant material was pressure-rolled to prepare a positive electrode.

### Preparation of Negative Electrode

Graphite serving as the negative electrode active material, styrene-butadiene rubber serving as a binder agent and carboxymethylcellulose sodium serving as a thickening agent were mixed together at a mass ratio of 98:1:1 in water to prepare a negative electrode slurry. The prepared negative electrode slurry was applied onto both sides of a negative electrode current collector made of a copper foil, and then dried. Thereafter, the resultant material was pressure-rolled, to obtain a negative electrode.

### Preparation of Non-Aqueous Electrolyte Solution

A mixed solvent of 3:7 volume ratio of ethylene carbonate and ethyl methyl carbonate was used as a non-aqueous solvent. LiPF₆ as an electrolyte was dissolved at a concentration of 1 mol/L in the mixed solvent, to obtain a non-aqueous electrolyte.

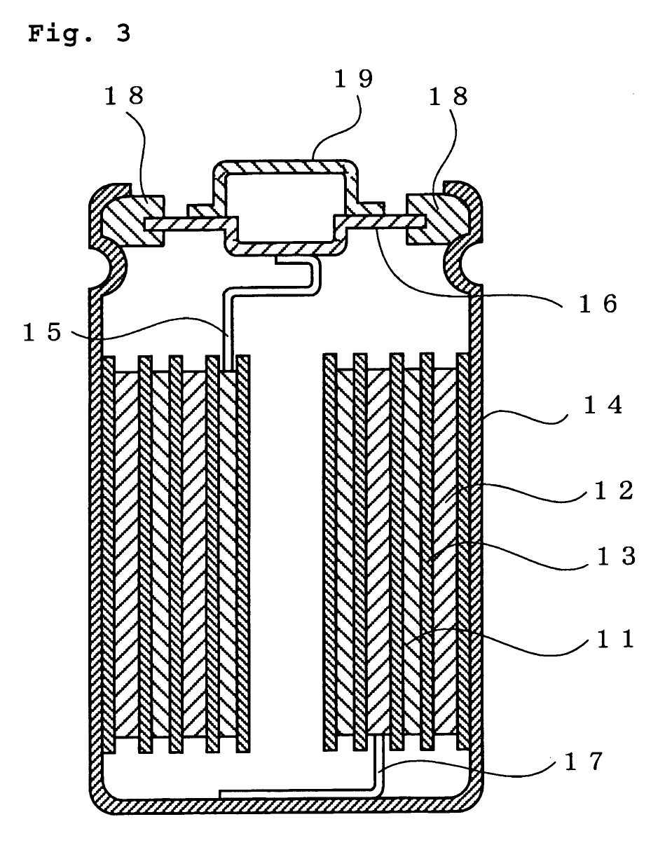

The non-aqueous electrolyte secondary battery A2 was prepared in the following manner. As illustrated in FIG. 3, a microporous polyethylene film, serving as a separator 13, that allows lithium ions to pass through, was interposed between the positive electrode 11 and the negative electrode 12, which were prepared in the above-described manner. These were spirally wound together and accommodated into a battery can 14. The positive electrode 11 was connected by a positive electrode tab 15 to a positive electrode external terminal 19 attached to a positive electrode plate 16, and the negative electrode 12 was connected to the battery can 14 by a negative electrode tab 17. Thereafter, the battery can 14 was filled with the above-described non-aqueous electrolyte solution, and the battery can 14 and the positive electrode plate 16 were electrically isolated by an insulative gasket 18 and sealed. Also the battery A2 was provided with a separator shutdown mechanism, a current shutoff valve, and a protective device. Also the battery A2 was provided with a separator shutdown mechanism, a current shutoff valve, and a protective device. Thus, a cylindrical non-aqueous electrolyte secondary battery A2, which has a design capacity of 1300 mAh, was obtained.

### Non-Aqueous Electrolyte Secondary Battery B2

A non-aqueous electrolyte secondary battery B2 was obtained in the same manner as described for the above-described non-aqueous electrolyte secondary battery A2, except that a positive electrode prepared in the following manner was used therein. The cylindrical non-aqueous electrolyte secondary battery B2 thus obtained had a design capacity of 1300 mAh. The battery B2 was also provided with a separator shutdown mechanism a current shutoff valve, and a protective device.

In the non-aqueous electrolyte secondary battery B2, the positive electrode was prepared as follows. An olivine-type lithium iron phosphate (LiFePO₄) (0.5 μm in particle diameter D₅₀) was used as the positive electrode active material. The positive electrode active material, artificial graphite powder (acetylene black made by Denkikagaku Kogyo Kabushiki Kaisha) serving as a conductive agent, and polyvinylidene fluoride (PVdF made by Kureha Corporation) serving as a binder agent were mixed at a mass ratio of 85:10:5 in a N-methyl-2-pyrrolidone solvent, to prepare a positive electrode mixture slurry. The resultant positive electrode mixture slurry was applied onto both sides of a positive electrode current collector made of an aluminum foil, and then dried. The resultant material was pressure-rolled to prepare the positive electrode.

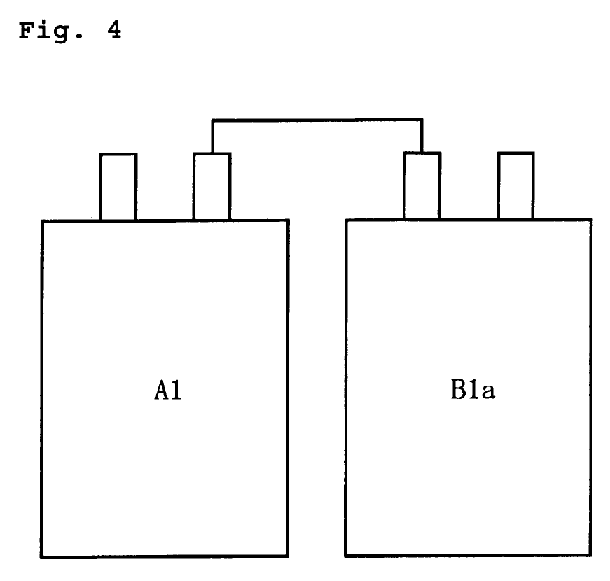

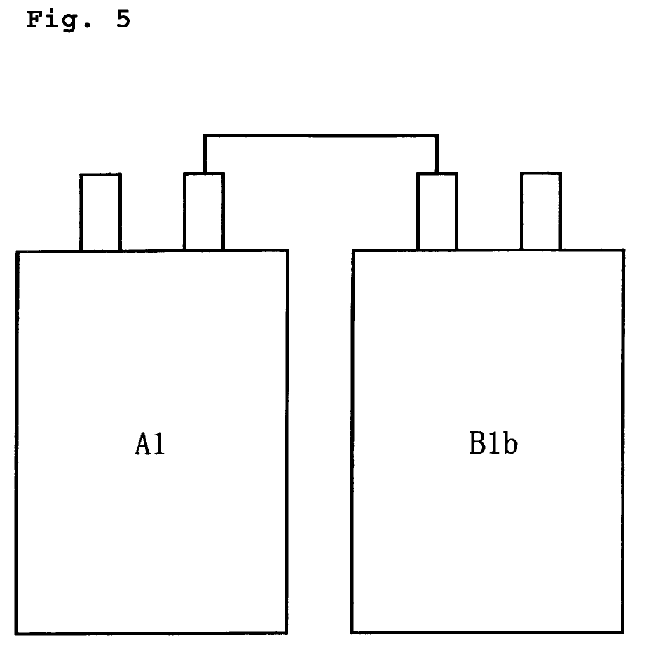

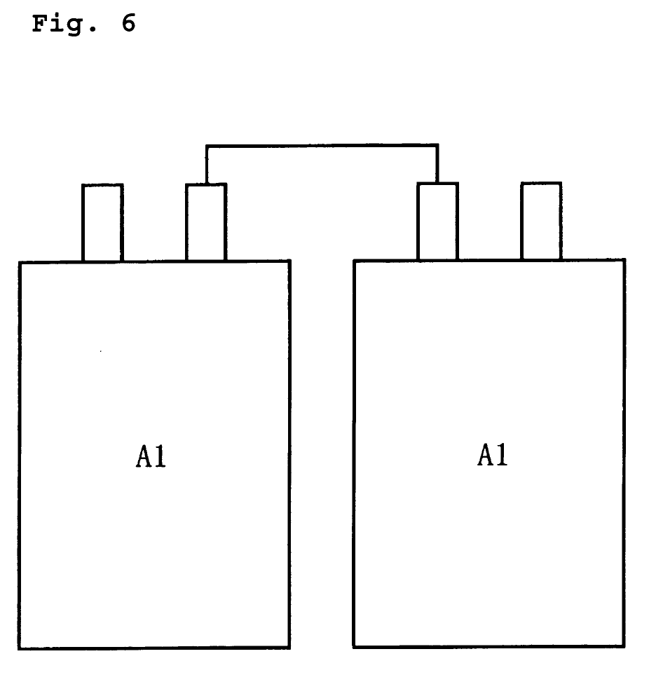

In a battery unit of Example 1, the card-shaped non-aqueous electrolyte secondary battery A1 and the card-shaped non-aqueous electrolyte secondary battery B1a were connected in series, as illustrated in FIG. 4. In a battery unit of Example 2, the card-shaped non-aqueous electrolyte secondary battery A1 and the card-shaped non-aqueous electrolyte secondary battery B1b were connected in series, as illustrated in FIG. 5. In a battery unit of Comparative Example 1, two card-shaped non-aqueous electrolyte secondary batteries A1 were connected in series, as illustrated in FIG. 6.

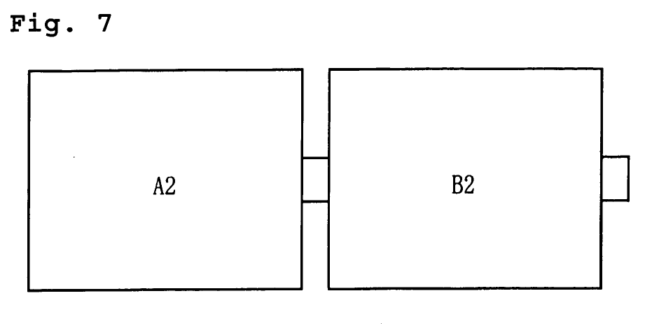

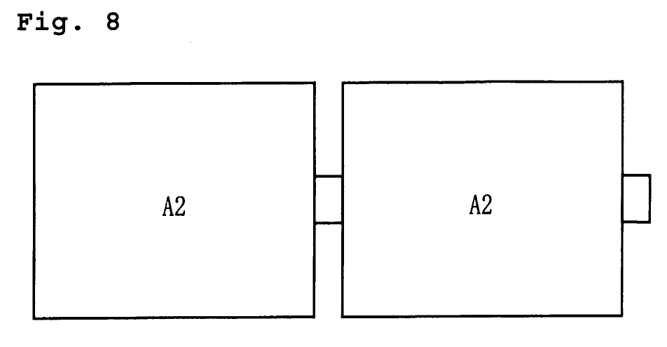

In a battery unit of Example 3, the cylindrical non-aqueous electrolyte secondary battery A2 and the cylindrical non-aqueous electrolyte secondary battery B2 were connected in series, as illustrated in FIG. 7. In a battery unit of Comparative Example 2, two cylindrical non-aqueous electrolyte secondary batteries A2 were connected in series, as illustrated in FIG. 8.

An overcharge test was conducted for each of the battery units, using 5 samples each. The samples of the battery units were charged at a charge current of 2340 mA (780 mA×3) for the battery units of Examples 1 and 2 and Comparative Example 1 and at a charge current of 3900 mA (1300 mA×3) for the battery units of Example 3 and Comparative Example 2 until the voltage reached 24 V. Thereafter, the samples were constant voltage charged at a constant voltage of 24 V until electric current flowed therethrough. The number of the samples in which the battery temperature greatly increased and internal short circuits occurred was obtained for each battery unit. The results are shown in Table 1 below. It should be noted that, in the above-described overcharge test, unlike commercially available non-aqueous electrolyte secondary batteries, the battery units were not provided with means for ensuring safety except for the separator shutdown mechanism, the current shut-off valve, and a protective device, in order to confirm the overcharge condition in the non-aqueous electrolyte secondary batteries.

TABLE 1

| | Non-aqueous electrolyte | | Number of samples in |
|---|---|---|---|
| | secondary battery | | which an overcharge |
| | | Positive electrode | condition was observed |
| | Battery | active material | (among 5 samples) |
| Example 1 | A1 | LiCoO₂ | 0 |
| | B1a | LiFePO₄ | |
| Example 2 | A1 | LiCoO₂ | 0 |
| | B1b | LiFePO₄ + LiCoO₂ | |
| Comparative | A1 | LiCoO₂ | 5 |
| Example 1 | A1 | LiCoO₂ | |
| Example 3 | A2 | LiNi_{0.3}Co_{0.3}Mn_{0.3}O₂ | 0 |
| | B2 | LiFePO₄ | |
| Comparative | A2 | LiNi_{0.3}Co_{0.3}Mn_{0.3}O₂ | 5 |
| Example 2 | A2 | LiNi_{0.3}Co_{0.3}Mn_{0.3}O₂ | |

The results demonstrate the following. In the battery unit of Comparative Example 1, two non-aqueous electrolyte secondary batteries A1, each of which employed a layered lithium-transition metal composite oxide LiCoO₂ as the positive electrode active material, were connected in series. Likewise, in the battery unit of Comparative Example 2, two non-aqueous electrolyte secondary batteries A2, each of which employed a layered lithium-transition metal composite oxide LiNi_{0.3}Co_{0.3}Mn_{0.3}O₂ as the positive electrode active material, were connected in series. All the five samples of each of the Comparative Examples 1 and 2 were brought into overcharge conditions, the battery temperature was increased significantly, and internal short circuits were caused.

In contrast, in the battery unit of Example 1 the non-aqueous electrolyte secondary battery A1, which used a layered lithium-transition metal composite oxide LiCoO₂ as the positive electrode active material, and the non-aqueous electrolyte secondary battery B1a, which used an olivine-type lithium iron phosphate (LiFePO₄) as the positive electrode active material, were connected in series. In the battery unit of Example 2, the above-described non-aqueous electrolyte secondary battery A1 and the non-aqueous electrolyte secondary battery B1b, in which the first layer comprising a positive electrode active material containing an olivine-type lithium iron phosphate LiFePO₄ and the second layer comprising a positive electrode active material containing lithium cobalt oxide (LiCoO₂) were stacked over a current collector, were connected in series. In the battery unit of Example 3, the non-aqueous electrolyte secondary battery A2, which used a layered lithium-transition metal composite oxide LiNi_{0.3}Co_{0.3}Mn_{0.3}O₂ as the positive electrode active material, and the non-aqueous electrolyte secondary battery B2, which used an olivine-type lithium iron phosphate LiFePO₄ as the positive electrode active material, were connected in series In all the five samples of each of these battery units of Examples 1 through 3, overcharge conditions were prevented, and neither significant battery temperature increases nor internal short circuits were observed.

It should be noted that similar results are obtained when a different type of olivine-type lithium phosphate compound or a spinel-type lithium-manganese composite oxide is used as the positive electrode active material having a lower potential at which lithium is released and the electrical resistance in the battery increases during charge, although the non-aqueous electrolyte secondary batteries B1a, B1b, and B2 in the foregoing examples used the olivine-type lithium iron phosphate (LiFePO₄).

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

This application claims priority of Japanese Patent Application No. 2007-024977 filed Feb. 5, 2007, which is incorporated herein by reference.

What is claimed is:

1. A battery unit comprising:
a plurality of non-aqueous electrolyte secondary batteries connected in series, wherein at least two types of non-aqueous electrolyte secondary batteries having different potentials at which lithium is released from a positive electrode active material and at which the electric resistance of the battery increases during charge are connected in series.

2. The battery unit according to claim 1, wherein: the plurality of non-aqueous electrolyte secondary batteries comprises a first non-aqueous electrolyte secondary battery having a higher potential at which lithium is released from the positive electrode active material and at which the electrical resistance in the battery increases during charge, and a second non-aqueous electrolyte secondary battery having a lower potential at which lithium is released from the positive electrode active material and at which the electrical resistance increases in the battery during charge than the first non-aqueous electrolyte secondary battery; the positive electrode active material in the first non-aqueous electrolyte secondary battery contains a layered lithium-transition metal composite oxide; and the positive electrode active material in the second non-aqueous electrolyte secondary battery contains an olivine-type lithium phosphate compound represented by the general formula LiMPO₄, where M is at least one element selected from the group consisting of Fe, Ni, and Mn, or contains a spinel-type lithium-manganese composite oxide.

3. The battery unit according to claim 2, wherein the positive electrode active material in the first non-aqueous electrolyte secondary battery comprises a lithium-transition metal composite oxide containing at least one element selected from the group consisting of cobalt and nickel.

4. The battery unit according to claim 2, wherein the positive electrode active material in the second non-aqueous electrolyte secondary battery comprises a spinel lithium manganese oxide represented by the formula LiMn₂O₄ or, as the olivine-type lithium phosphate compound, an olivine-type lithium iron phosphate represented by the formula LiFePO₄.

5. The battery unit according to claim 2, wherein the positive electrode of the second non-aqueous electrolyte secondary battery comprises a first layer and a second layer stacked on a positive electrode current collector, the first layer in contact with the positive electrode current collector comprising a positive electrode active material containing an olivine-type lithium phosphate compound represented by the general formula LiMPO₄, where M is at least one element selected from the group consisting of Fe, Ni, and Mn, or a spinel-type lithium-manganese composite oxide, and the second layer comprising a positive electrode active material containing a layered lithium-transition metal composite oxide.

6. The battery unit according to claim 2, wherein at least the second non-aqueous electrolyte secondary battery, having a lower potential at which lithium is released from the positive electrode active material and at which the electrical resistance in the battery increases during charge, is furnished with a current shut-off valve that is actuated by a battery internal pressure increase.
